(19) United States
(12) Patent Application Publication
(10) Pub. No.: US 2012/0296599 A1
(43) Pub. Date: Nov. 22, 2012

(54) TEMPERATURE SENSING SYSTEM AND METHOD

(75) Inventors: BIN LIU, Shenzhen City (CN); WEN-WU WANG, Shenzhen City (CN); WEN-DONG LUO, Shenzhen City (CN); TSUNG-JEN CHUANG, Tu-Cheng (TW); SHIH-FANG WONG, Tu-Cheng (TW)

(73) Assignees: HON HAI PRECISION INDUSTRY CO., LTD., Tu-Cheng (TW); FU TAI HUA INDUSTRY (SHENZHEN) CO., LTD., ShenZhen City (CN)

(21) Appl. No.: 13/207,429

(22) Filed: Aug. 11, 2011

(30) Foreign Application Priority Data
May 20, 2011 (CN) 201110131633.2

(51) Int. Cl. G01J 5/00; G06F 15/00

(52) U.S. Cl. 702/135; 702/130

(57) ABSTRACT

A temperature sensing system used to test the temperature of a surface of a to-be-tested object includes an image capturing unit to capture an image of a base supporting the to-be-tested object. A host obtains and displays the captured image, and maps the image to a coordinate system. Each point of the image corresponds to a coordinate of the coordinate system. The host further determines the coordinate of a selected point of the displayed image. A temperature sensing unit senses the temperature of the surface of the to-be-tested object according to the coordinate of the selected point of the displayed image. A method for sensing the temperature of surface of a to-be-tested object is also provided.

### BACKGROUND

1. Technical Field

The present disclosure relates to temperature sensing systems, and particularly, to a temperature sensing system for sensing the temperature of a surface of an electronic device and a method thereof.

2. Description of Related Art

During manufacturing of electronic devices, it is necessary to test the temperature of the surfaces of the electronic devices. A known method for this test is to paste a thermocouple temperature sensor in a proper position on a surface of the electronic device manually. However, if the temperature sensor is not positioned properly, it may not get the correct result. Therefore, using the known method may cause difficulty for the operators who are in charge of pasting the thermocouple temperature sensors on the surfaces of the electronic devices. Furthermore, pasting the thermocouple temperature sensors manually may damage the thermocouple temperature sensors and is inefficient.

### BRIEF DESCRIPTION OF THE DRAWINGS

Many aspects of the present disclosure should be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a block diagram of a temperature sensing system in accordance with an exemplary embodiment.

FIG. 2 is a schematic view of the temperature sensing system of FIG. 1.

FIG. 3 is a flowchart of a temperature sensing method in accordance with an exemplary embodiment.

### DETAILED DESCRIPTION

Embodiments of the present disclosure will now be described in detail, with reference to the accompanying drawings.

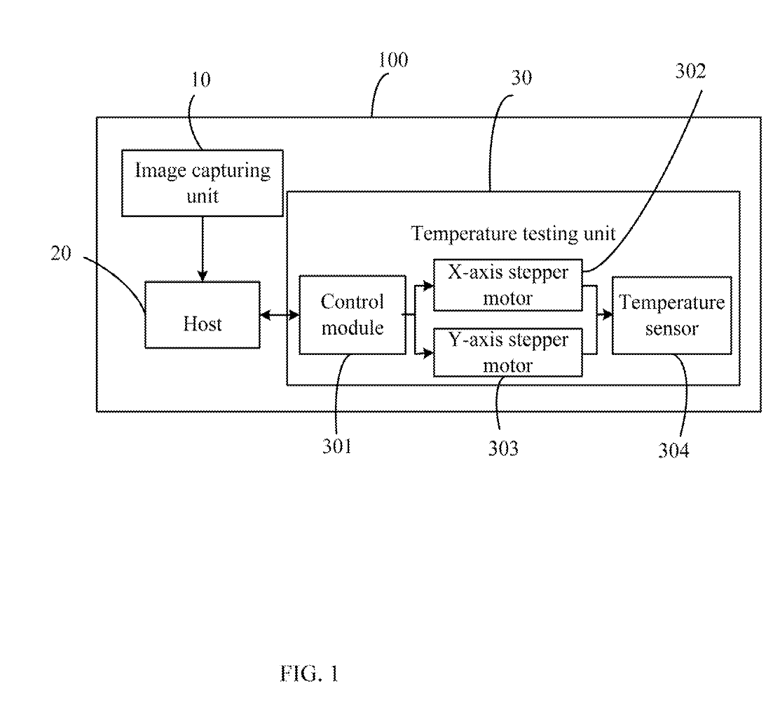

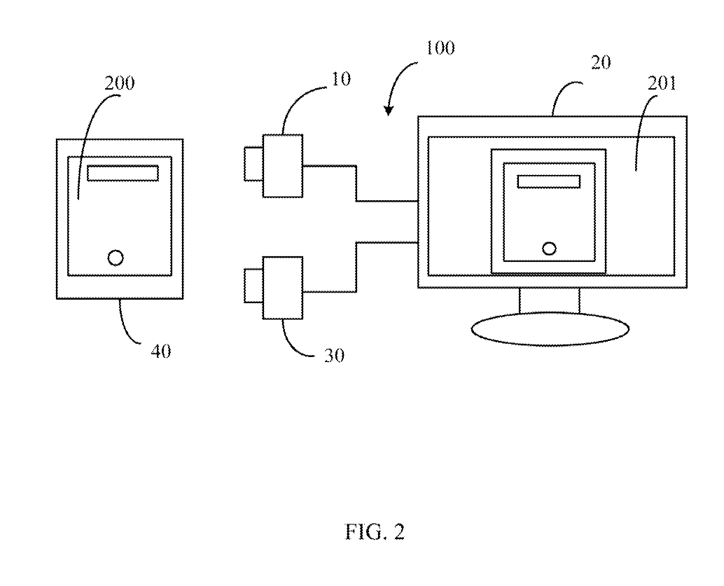

Referring to FIGS. 1-2, a temperature sensing system 100 is used to test the temperature of a surface of a to-be-tested object 200. The system 100 includes an image capturing unit 10, a host 20, a temperature sensing unit 30, and a base 40. The base 40 is used to support the object 200. The host 20 may be a computer.

The image capturing unit 10 is connected to the host 20 and is used to capture an image of the base 40 containing the object 200.

The host 20 obtains the image captured by the image capturing unit 10, displays the captured image on a display 201 of the host 20, and maps the image to a coordinate system. Each point of the image corresponding to a coordinate of the coordinate system.

The host 20 further determines the coordinates of a selected point of the displayed image. A user can select a point of the displayed image using a mouse or a stylus if the display 201 is a touch-sensitive screen.

The temperature sensing unit 30 communicates with the host 20 via a data line (not shown). The temperature sensing unit 30 senses the temperature of the surface of the object 200 according to the coordinate of the selected point of the displayed image. In this embodiment, the temperature sensing unit 30 includes a control module 301, an X-axis stepper motor 302, a Y-axis stepper motor 303, and a temperature sensor 304. The control module 301 has current coordinates of the motors 302, 303. The control module 301 controls the X-axis stepper motor 302 and the Y-axis stepper motor 303 to move the temperature sensor 304 to a proper position to sense the surface of the object 200 according to current coordinates of the motors 302, 303, and the coordinate of the selected point of the displayed image. The control module 301 transmits the temperature sensed by the temperature sensor 304 to the host 20. In this embodiment, the temperature sensor 304 is an infrared temperature sensor. With such configuration, there is no need to paste a temperature sensor to a proper position of a surface of a to-be-tested object. The system 100 can automatically move the temperature sensor 304 to the proper position to test the temperature of the surface of the object when a user selects a point to-be-tested of the image, which increases testing efficiency, giving accurate test results, and causes no damage to the temperature sensor 304.

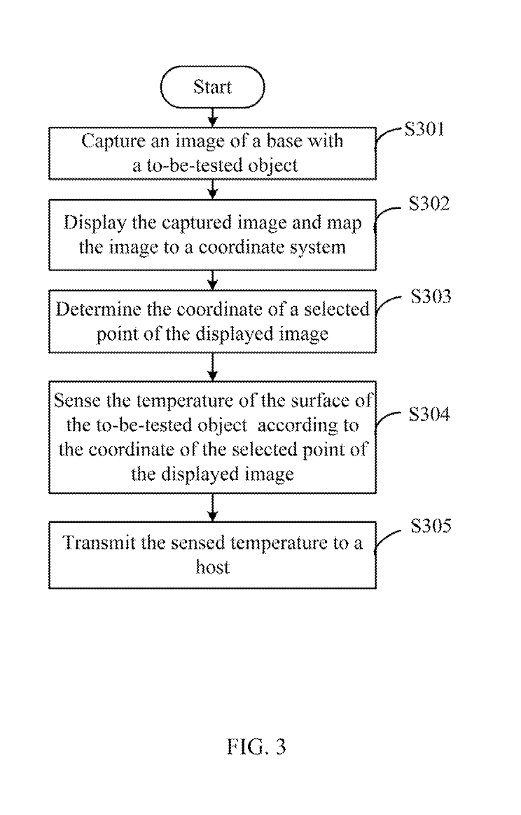

FIG. 3 is a flowchart of a temperature sensing method in accordance with an exemplary embodiment.

In step S301, the image capturing unit 10 captures an image of the base 40 supporting the object 200.

In step S302, the host 20 obtains the image captured by the image capturing unit 10, displays the captured image on the display 201, and maps the image to a coordinate system. Each point of the image corresponds to a coordinate of the coordinate system.

In step S303, the host 20 determines the coordinate of a selected point of the displayed image. A user can select a point of the displayed image using a mouse or a stylus if the display 201 is a touch-sensitive screen.

In step S304, the temperature sensing unit 30 senses the temperature of the surface of the object 200 according to the coordinate of the selected point of the displayed image. In one embodiment, the control module 301 controls the X-axis stepper motor 302 and the Y-axis stepper motor 303 to move the temperature sensor 304 to a proper position to sense the surface of the object 200 according to the current coordinates of the motors 302, 303, and the coordinate of the selected point of the displayed image.

In step S305, the control module 301 transmits the temperature sensed by the temperature sensor 304 to the host 20.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being exemplary embodiments of the present disclosure.

What is claimed is:

1. A temperature sensing system for testing the temperature of a surface of a to-be-tested object, comprising:
a base to support the object to-be-tested;
an image capturing unit to capture an image of the base supporting the to-be-tested object;
a host to obtain the image captured by the image capturing unit, display the obtained image on a display of the host, and map the image to a coordinate system, the host further to determine the coordinates of a selected point of the displayed image; and
a temperature sensing unit to sense the temperature of the surface of the to-be-tested object according to the coordinates of the selected point of the displayed image.

2. The temperature sensing system as described in claim 1, wherein the host determines the coordinate of the selected point on the displayed image by obtaining a select operation at the point using a mouse.

3. The temperature sensing system as described in claim 1, wherein the display of the host is a touch-sensitive screen, and the host determines the coordinates of the selected point on the displayed image by obtaining a select operation at the point using a stylus.

4. The temperature sensing system as described in claim 1, wherein the temperature sensing unit comprises a control module, an X-axis stepper motor, a Y-axis stepper motor, and a temperature sensor, the control module has current coordinates of the X-axis stepper motor and the Y-axis stepper motor, the control module is to control the X-axis stepper motor and the Y-axis stepper motor to move the temperature sensor to a proper position to sense the surface of the to-be-tested object according to the current coordinates of the motors, and the coordinates of the selected point of the displayed image.

5. The temperature sensing system as described in claim 4, the temperature sensor is an infrared temperature sensor.

6. A method for sensing the temperature of a surface of a to-be-tested object contained in a base, the method comprising:
capturing an image of the base supporting the to-be-tested object;
obtaining the image, displaying the image, and mapping the image to a coordinate system, each point of the image corresponding to a coordinate of the coordinate system;
determining the coordinates of a selected point of the displayed image;
sensing the temperature of the surface of the object according to the coordinates of the selected point of the displayed image; and
transmitting the sensed temperature to a host.

7. The temperature sensing method as described in claim 6, wherein the temperature sensing method is applied in a temperature sensing system, the temperature sensing system comprises a temperature sensing unit, the temperature sensing unit comprises an X-axis stepper motor, a Y-axis stepper motor, and a temperature sensor, the step of sensing the temperature of the surface of the object according to the coordinates of the selected point of the displayed image comprising:
controlling the X-axis stepper motor and the Y-axis stepper motor to move the temperature sensor to a proper position to sense the surface of the to-be-tested object according to current coordinates of the motors, and the coordinates of the selected point of the displayed image.
